(19) United States
(12) Patent Application Publication
(10) Pub. No.: US 2008/0028564 A1
(43) Pub. Date: Feb. 7, 2008

(54) Wiper blade support structure

(76) Inventor: Shu-Lan Ku, Hsingchuang City (TW)

Correspondence Address: HARNESS, DICKEY & PIERCE, P.L.C., P.O. BOX 828, BLOOMFIELD HILLS, MI, 48303, US

(21) Appl. No.: 11/498,964

(22) Filed: Aug. 4, 2006

(51) Int. Cl. B60S 1/38

(52) U.S. Cl. 15/250.43; 15/250.361; 15/250.32

(57) ABSTRACT

After being mounted with a wiper blade and a bridge base, a windshield wiper assembly can be combined with a wiper arm via a housing mounted on the bridge Base. The wiper blade support of the invention possesses a weight adjustment design allowing the pressure applied by the wiper arm at the central portion to be evenly distributed toward the ends of the wiper blade so as to make the wiper blade adapt to the radian of any windshields for closely contact the windshield. As such, the wiper blade is able to achieve better performance in wiping off rain.

### FIELD

A wiper blade support is designed to mount a wiper blade. The invention relates, in particular, to a windshield wiper blade of weight adjustment design.

### BACKGROUND

In order to fit onto various automobiles from different manufacturers, the windshield wiper assemblies sold on the market are too diverse to be standardized. With reference to FIG. 1, which is a perspective view of a windshield wiper of the prior art, the windshield wiper assembly 10 comprises a metal wiper frame 101, a wiper blade support 102 and a wiper blade 103. Besides, an adapter 1011 can be mounted on the wiper frame 101 to connect the windshield wiper assembly to a wiper arm. The structure of the windshield wiper assembly is complicated resulting in complex production and increased costs. Hence, a type of windshield wiper assembly, comprising a mono-blade support, is put on the market as per FIG. 2, wherein a wiper blade support 20 consists of a simple structure allowing the wiper blade support 20, after installation, to deflect and contact the windshield due to its flexibility and pre-shaped camber. Nevertheless, this mono-blade windshield wiper is still unsatisfactory for the following reasons. The key reason is that the pressure on the two ends of the wiper blade support 20 is relatively small. The connecting device for connecting the wiper arm to the wiper blade support 20 as well as the wiper arm mounted thereto apply pressure to a fixed position of the wiper blade support 20. Consequently, the downward pressure on the two ends is relatively small due to the smaller moment arms from the ends to the central portion. Another reason is that this mono-blade windshield wiper hardly achieves consistent performance: the windshield wiper sometimes fails to clean the windshield well because the windshield radian, the force applied by the wiper arm and the length of the wiper arm for different (automobile) models are different. Windshield wipers of the same specifications do not perform the same on automobiles of the same model. Consequently, this windshield wiper assembly does not meet a high level of user satisfaction and fails to receive consistent evaluations.

### SUMMARY

In view of the said drawbacks, the invention addresses an improved structure through analysis and study on each component. The objective of the invention is to provide a wiper blade support that uses the weight adjustment design so as to allow the wiper blade to closely contact the windshield after the windshield wiper assembly is connected to the wiper arm.

In one form, a wiper blade support includes two opposing support strips that define therebetween an insertion channel adapted for insertion of a wiper blade. The support strips each define at least one weight adjustment aperture for adjusting the weight of the wiper blade support.

In another form, the wiper blade support includes two support strips each having a central portion and opposing ends and connected at the opposing ends. The support strips define a longitudinal insertion channel therebetween and each define a plurality of weight adjustment apertures adjacent to the ends of the support strips for reducing the weight of the ends of the support strips. The weight adjustment apertures adjacent to the ends being larger than the weight adjustment apertures adjacent to the central portion.

In still another form, a wipe blade assembly includes a support strip having a central portion and opposing ends and defining a plurality of weight adjustment apertures for reducing the weight of the opposing ends; and a bridge base mounted to the support strip for connecting the support strip to a wiper arm.

The wiper blade support of the disclosure includes a plurality of weight adjustment apertures on different positions so as to make the two ends lighter than the central section. As such, the wiper blade support, coupled with a housing, is able to effectively distribute the pressure applied by the housing toward the extreme ends so as to make the whole wiper blade closely contact the windshield for better cleaning.

Further aspects, objects, and desirable features of the invention will be better understood from the detailed description and drawings that follow in which the embodiment of the disclosed invention is illustrated by way of example.

### DRAWINGS

FIG. 1 is a perspective view showing the appearance of the windshield wiper assembly of the prior art.

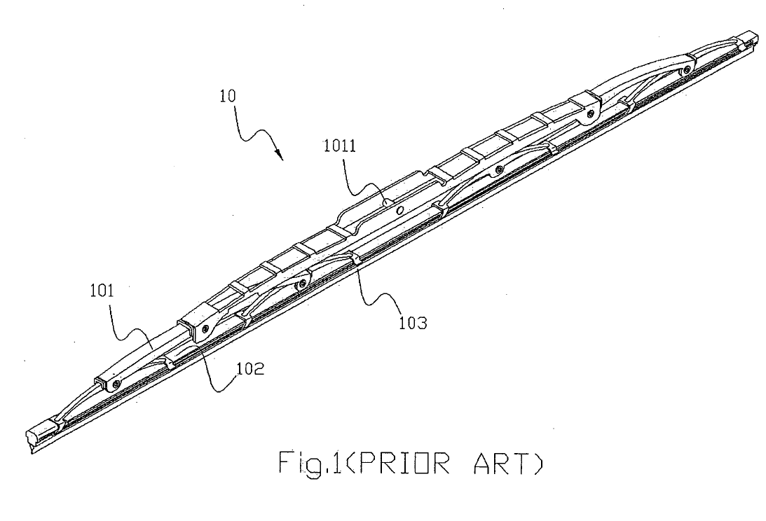

FIG. 2 is a perspective view showing a mono-blade windshield wiper assembly of the prior art.

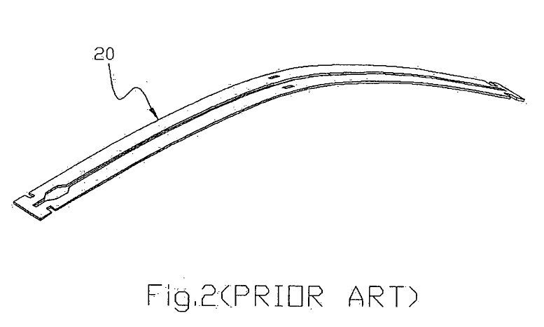

FIG. 3 is a perspective view showing the wiper blade support of the present invention.

FIG. 4 is a top view showing pressure analysis of the wiper blade support of the present invention.

FIG. 5 is a partial perspective view showing an embodiment of the present invention.

FIG. 6 is a cross sectional view showing an embodiment of the present invention.

FIG. 7 is a side view showing an embodiment of the present invention.

FIG. 8 is a top view showing embodiment (I) of the present invention.

FIG. 9 is a top view showing embodiment (II) of the present invention.

FIG. 10 is a perspective view showing embodiment (III) of the present invention.

### DESCRIPTION

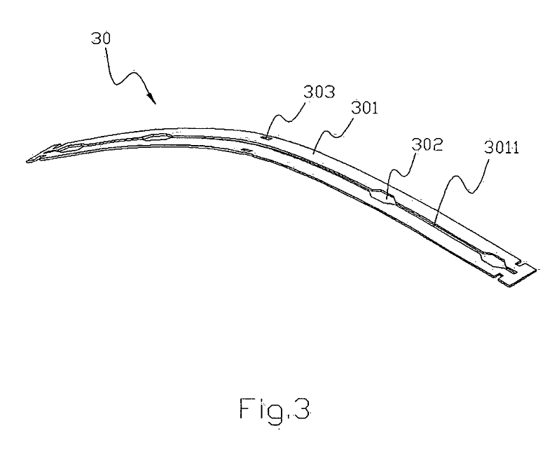

With reference to FIG. 3, the wiper blade support 30 of the invention comprises the support strip 301, which is punched with a plurality of weight adjustment apertures 302 so as to adjust the weight of different sections. In addition, the central section of the support strips is punched with a pair of positioning holes 303 for mounting a housing or a bridge base. Furthermore, the support strip is divided into two opposing support strips 301 by an interstice, which serves as an insertion channel 3011 for inserting the wiper blade 304 (not illustrated).

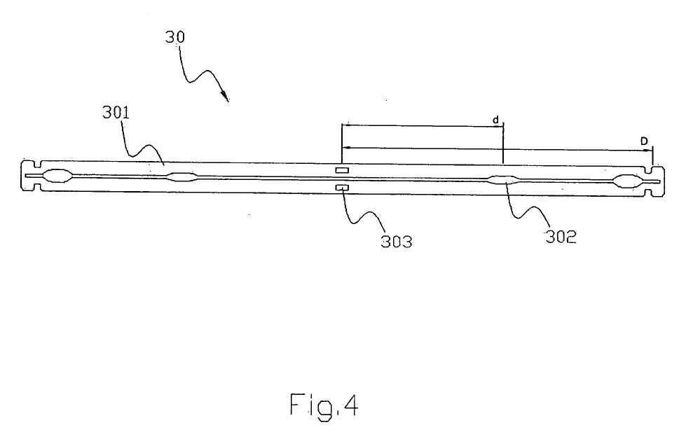

With reference to FIG. 4, the bridge or housing is positioned in the center of the wiper blade support 30 so as to allow the pressure exerted by the bridge or housing to be evenly distributed toward the two ends. As shown in FIG. 4, points “d” and “D” indicate the hypothetical locations where force is applied. It is obvious that the distance from the central point of the support strip 301 to point “D” is longer than that to point “d” because point “D” is located at the extreme end on the right side of the blade support strip 301 and point “d” is half way. In other words, the moment arm from point “D” to the central point (fulcrum) is longer than that from point “d” to the central point. Consequently, the pressure exerted at point “D” is smaller than that at point “d” when the downward pressure received by the wiper blade support is distributed towards the two ends. The foregoing description reveals that the wiper blade installed on the wiper blade support 30 has uneven pressure distribution because the pressure is eventually attenuated from the center to the extreme ends. In addition, the smaller pressure on the extreme ends causes the wiper blade to be incapable of thoroughly cleaning the windshield. With reference to FIG. 4, in order to make the pressure at the ends close to the pressure at the central point, two solutions are available: one is to increase the weight of the extreme ends of the blade support strip, and the other is to reduce the weight thereof to allow the pressure applied to the center point of the support strip 301 to be evenly distributed toward the extreme end. The former relates to the design of weight load to make the extreme ends of the support strip 301 heavier (to produce downward pressure) by increasing external force thereon. The latter appears to be a more practical solution in consideration of production costs. With reference to FIG. 4, the weight adjustment aperture 302 is formed adjacent to the extreme ends for reducing the weight of the wiper blade. Preferably, the farther the weight adjustment aperture 302 is from the central portion, the larger the weight adjustment aperture 302. The weight adjustment aperture 302 is formed by stamping to effectively reduce the weight of the support strip so as to allow the pressure to be evenly distributed toward the extreme ends.

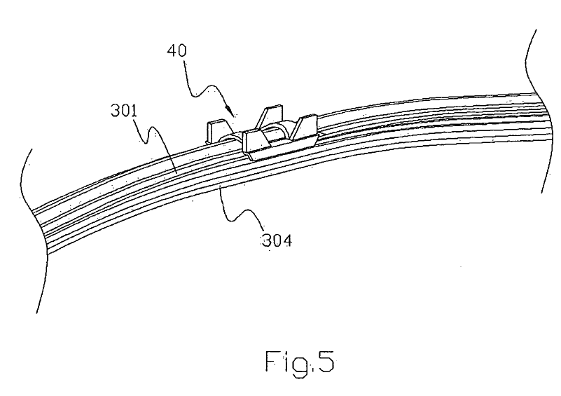

With reference to FIG. 5, a bridge base 40 is mounted on the wiper blade support 30 of the invention by engaging the bridge base 40 to the positioning holes 303.

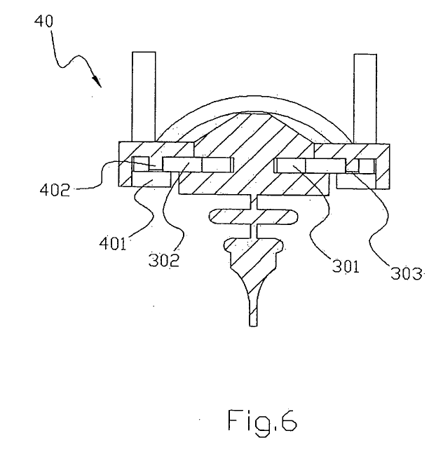

With reference to FIG. 6, which is a cross sectional view showing a bridge base 40 engaging the positioning holes 303, the bridge base 40 is mounted on the wiper blade support 30 through engaging the bridge base 40 to the positioning holes 303. Several pins 401 on the bottom of the bridge base 40 clamp the longitudinal edges of the support strip 301. Besides, several tenons 402 on the bottom of the bridge base 40 are mortised into the positioning holes 303 of the support strip 301. A housing can be mounted on the bridge base 40.

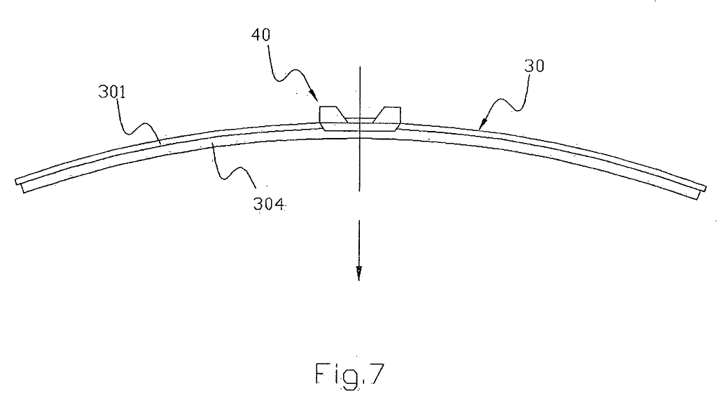

With reference to FIG. 7, in normal cases, the bridge base 40 or housing (not illustrated) is installed in the central position of the wiper blade support 30 if the windshield has an even radian and the wiper arm has an even force application.

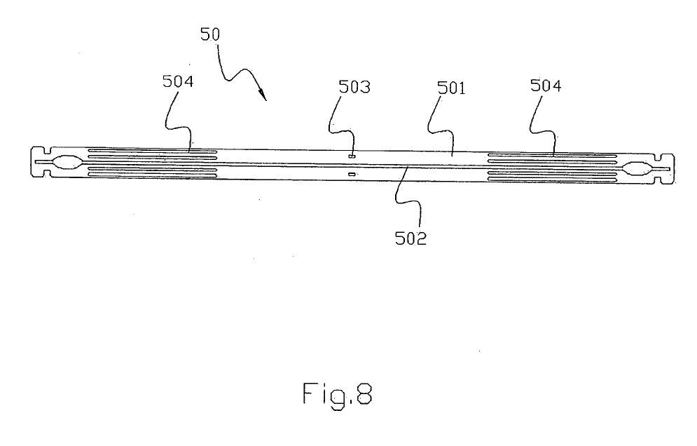

With reference to FIG. 8, the wiper blade support 50 comprises two opposing support strips 501 that form an insertion channel 502 for blade insertion. In addition, the support strips 501 comprise positioning holes 503, which are located on the central position for mounting the bridge base, and several weight adjustment apertures 504, which are stamped oblong interstices between the central position and the extreme ends so as to make the extreme ends lighter than the central position. As such, the wiper blade support 50 is able to evenly distribute the pressure applied to the central position to the extreme ends of the support strips 501. The weight adjustment apertures are aligned in a transverse direction of the support strips 501.

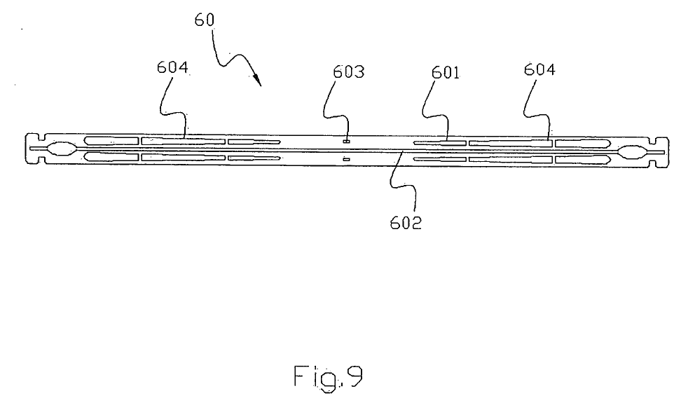

With reference to FIG. 9, the wiper blade support 60 comprises two opposing support strips 601 that form an insertion channel 602 for blade insertion. Furthermore, the support strips 601 comprise positioning holes 603, which are located on the central position for mounting the bridge and several weight adjustment apertures 604, which are stamped oblong interstices. The oblong interstices are aligned along a longitudinal direction of the support strips and each have a tapered shape with a varied width. The width of each oblong interstice is at its smallest adjacent to the central portion of the support strips and at its largest adjacent to one of the extreme ends of the support strips. Moreover, among the oblong interstices, the farther the interstices are from the central portion of the support strips, the larger the weight adjustment apertures 604 so as to make the extreme ends lighter than the central portion of the support strips. As such, the wiper blade support 60 is able to evenly distribute the pressure applied to the central position toward the extreme ends of the support strips 601.

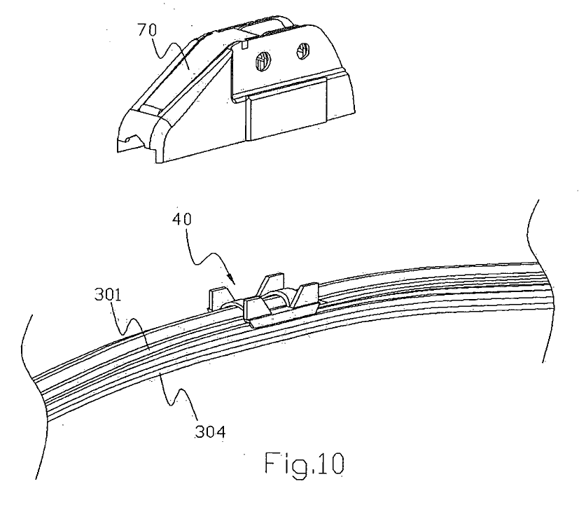

With reference to FIG. 10, a housing 70 used to connect the windshield wiper assembly to the wiper arm, is mounted on a bridge base 40 that is mounted on a wiper blade support 30. After the windshield wiper assembly is connected to the wiper arm via a housing, movement of the wiper arm causes the wiper blade 303 to deflect and contact the windshield to wipe off water drops.

The foregoing embodiments exhibit that wiper blade support of the invention mainly relates to a weight adjustment design on the surface, which makes the wiper blade support have less weight at the extreme ends than that at the central position so that the pressure applied to the central position is evenly distributed toward the extreme ends. This design provides the mono-blade windshield wiper assembly with an optimal radian to maximize its practicality.

To sum up, by the weight adjustment design, the invention achieves a wiper blade support assuring the wiper blade to completely and closely contact the windshield after a windshield wiper assembly is connected to a wiper arm.

New characteristics and advantages of the invention covered by this document have been set forth in the foregoing description. Understanding is sought however, that the drawings are for the purpose of illustration only and not intended to limit the invention. Changes in methods, shapes, structures, or devices may be made in detail without departing from the scope of the invention by those who are skilled in the art. The scope of the invention is, of course, defined in the appended claims.

1-7. (canceled)

8. A wiper blade support comprising:
two opposing support strips that define therebetween an insertion channel adapted for insertion of a wiper blade, the support strips each defining at least one weight adjustment aperture for adjusting the weight of the wiper blade support.

9. The wiper blade support of claim 8, wherein the support strips each have a central portion and two ends, wherein the at least one weight adjustment aperture is so disposed that the weight of at least one of the ends is reduced.

10. The wiper blade support of claim 9, wherein the at least one weight adjustment aperture is formed adjacent to the at least one of the ends of the support strips.

11. The wiper blade support of claim 10, wherein the at least one weight adjustment aperture is oblong and extends in a longitudinal direction of the support strips.

12. The wiper blade support of claim 8, wherein the support strips each define a plurality of weight adjustment apertures.

13. The wiper blade support of claim 12, wherein the plurality of weight adjustment apertures are oblong and extend in a longitudinal direction of the support strips.

14. The wiper blade support of claim 13, wherein the weight adjustment apertures adjacent to opposing ends of the support strips are larger than the weight adjustment apertures adjacent to a central portion of the support strips.

15. The wiper blade support of claim 14, wherein the weight adjustment apertures each have a varied width, wherein the width is at its smallest adjacent to the central portion and at its largest adjacent to the ends of the support strips.

16. The wiper blade support of claim 13, wherein the weight adjustment apertures are aligned along a longitudinal direction of the support strips.

17. The wiper blade support of claim 13, wherein the weight adjustment apertures are aligned along a transverse direction of the support strips.

18. The wiper blade support of claim 8, wherein each support strip defines at least one positioning hole in a central portion thereof.

19. The wiper blade support of claim 8, wherein the wiper blade support is formed as one piece.

20. The wiper blade support comprising:
two support strips each having a central portion and opposing ends and connected at the opposing ends, the support strips defining a longitudinal insertion channel therebetween and each defining a plurality of weight adjustment apertures adjacent to the ends of the support strips for reducing the weight of the ends of the support strips, the weight adjustment apertures adjacent to the ends being larger than the weight adjustment apertures adjacent to the central portion.

21. The wiper blade support of claim 20, wherein the weight adjustment apertures have a varied width, the width being at its smallest adjacent to the central portion and at its largest adjacent to the ends.

22. The wiper blade support of claim 20, wherein the weight adjustment apertures are aligned in a longitudinal direction of the support strips.

23. The wiper blade support of claim 20, wherein the weight adjustment apertures are aligned in a transverse direction of the support strips.

24. A wiper blade assembly comprising:
a support strip having a central portion and opposing ends and defining a plurality of weight adjustment apertures for reducing the weight of the opposing ends; and
a bridge base mounted to the support strip for connecting the support strip to a wiper arm.
